(19) United States
(12) Patent Application Publication
(10) Pub. No.: US 2017/0320712 A1
(43) Pub. Date: Nov. 9, 2017

(54) WINCH AND METHOD FOR USING THE SAME

(71) Applicant: ACTION PRODUCTS MARKETING CORP., Johnston, IA (US)

(72) Inventors: William E. Shook, Johnston, IA (US); Keith Raymond Walker, Johnston, IA (US); Francis Colin Geoffrey Melton, Johnston, IA (US); Danny C. Jury, Ankeny, IA (US)

(21) Appl. No.: 15/584,479

(22) Filed: May 2, 2017

Related U.S. Application Data
(60) Provisional application No. 62/332,046, filed on May 5, 2016.

(51) Int. Cl. B66D 1/50; B66D 1/36; B66D 1/24; B66D 1/12; B66D 1/08

(52) U.S. Cl. CPC B66D 1/50; B66D 1/36; B66D 1/08; B66D 1/12; B66D 2700/0125; B66D 1/24

(57) ABSTRACT

Disclosed is a motorized winch system having a frame, a motor, and a drum with a first end and a second end connected to the motor. The system has a winch cable configured to wind around the drum with a first end connected to the drum, having a winding portion and a distal portion. The system has a winch cable locator assembly with a cam bar rotatably mounted to the frame, a cam follower connected to the cam bar such that the cam follower slides from the first end to the second end of the drum and reverses to slide back to the first end of the drum, and a cable guide coupled to the cam follower, configured to guide the cable onto the drum. The system has a removable cam gear with an operating position operably connected to the motor, and a manual position disconnected from the motor.

### CROSS-REFERENCE TO RELATED APPLICATION

This application claims priority to and the benefit of U.S. Provisional Patent Application Ser. No. 62/332,046, filed on May 5, 2016, entitled “NEW WINCH AND METHOD FOR USING THE SAME,” the disclosure of which is hereby incorporated herein by reference in its entirety.

### BACKGROUND OF THE DISCLOSURE

Winches may be used in a variety of applications. They are often attached to a vehicle for easy portability, or may be a stand-alone unit that may be transferred from place to place and supported by a vehicle, or a different stationary object to support the winch in its towing capacity.

In certain applications, it is important to keep tension on the tow cable at all times, and with a constant force. These applications may include using a winch to draw a pipe lining apparatus through a storm or sanitary pipe of concrete, clay, brick, corrugated metal, or other material. In order for the lining to be applied uniformly, it may be necessary to pull the apparatus at a constant rate through the pipe.

### SUMMARY OF THE PRESENT INVENTION

One aspect of the present invention includes a motorized winch system having a frame, a motor, and a drum with a first end and a second end connected to the motor. The system has a winch cable configured to wind around the drum with a first end connected to the drum, having a winding portion and a distal portion. The system has a winch cable locator assembly with a cam bar rotatably mounted to the frame, a cam follower connected to the cam bar such that the cam follower slides from the first end to the second end of the drum and reverses to slide back to the first end of the drum, and a cable guide coupled to the cam follower, configured to guide the cable onto the drum. The system has a removable cam gear with an operating position operably connected to the motor, and a manual position disconnected from the motor.

Another aspect of the present invention includes a portable winch system having a frame with a handle, a motor attached to the frame, a spool operably connected to the motor and rotatably mounted to the frame, and a winch cable attached to the spool. The system has a winch cable locator assembly having a cam bar rotatably mounted to the frame and having a guide portion, a cam follower rotatably disposed on the cam bar and engaging the guide portion, a cable guide coupled to the cam follower and slidably engaged with the winch cable, a cam gear slidably disposed on and rotatably engaged with the cam bar and having an operating position wherein the cam bar is operably connected to the motor, and a manual position wherein the cam bar is operably disconnected from the motor.

Yet another aspect of the present invention is a method for winching an apparatus by providing a winch including a frame, motor, and drum, winding a winch cable about the drum by rotating the drum with the motor, providing constant pressure on the winch cable that is wrapped on the drum with a pressure plate disposed on the frame, and driving a cam by attaching a chain at a first end to the motor and at a second end to a cam sprocket, slidably attaching a cam gear to the cam, moving the cam gear to a first position, wherein the cam gear and the cam sprocket are operably coupled. The method includes guiding the winch cable by providing a cable guide on a cam follower, threading the winch cable through the cable guide, operably and slidably attaching the follower to the cam such that a protrusion on the cam follower is disposed within guide grooves on the cam, and translating rotational movement of the cam to slidable linear motion of the cam follower such that the winch cable is generally uniformly wound onto the drum.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is an isometric view of the winch system as described.

FIG. 2 is a close up view of a hydraulic system.

FIG. 3 is a perspective view of the motor and cam systems.

FIG. 3A is an exploded view of the cam system.

FIG. 4 is an isometric view of the cam.

FIG. 5 is the drum cable windings and pressure plate.

FIG. 6A is the cam gear system in the operating position.

FIG. 6B is the cam gear system in the manual position.

### DETAILED DESCRIPTION OF EXEMPLARY EMBODIMENTS

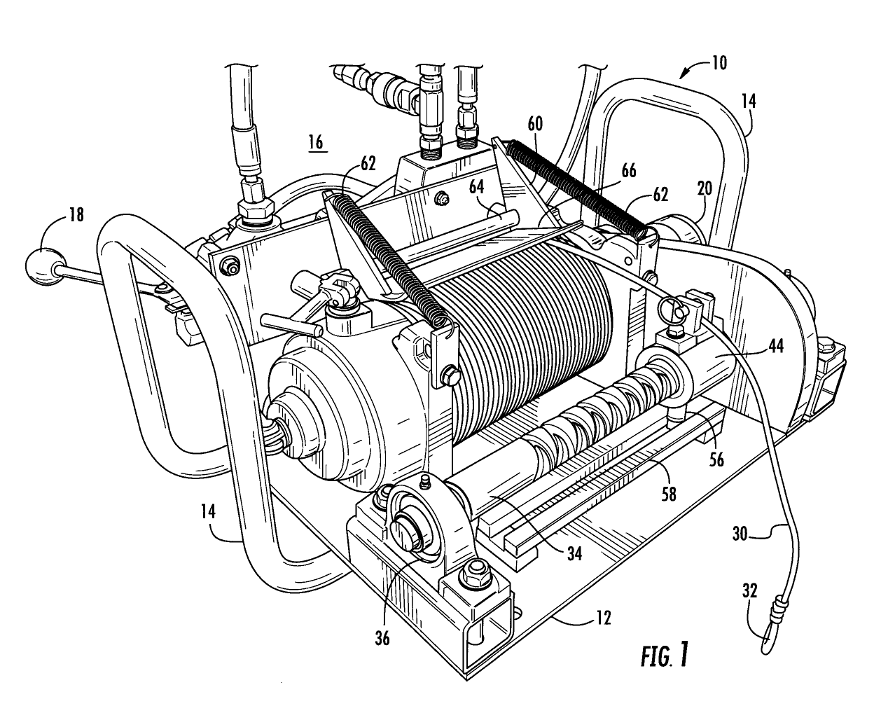

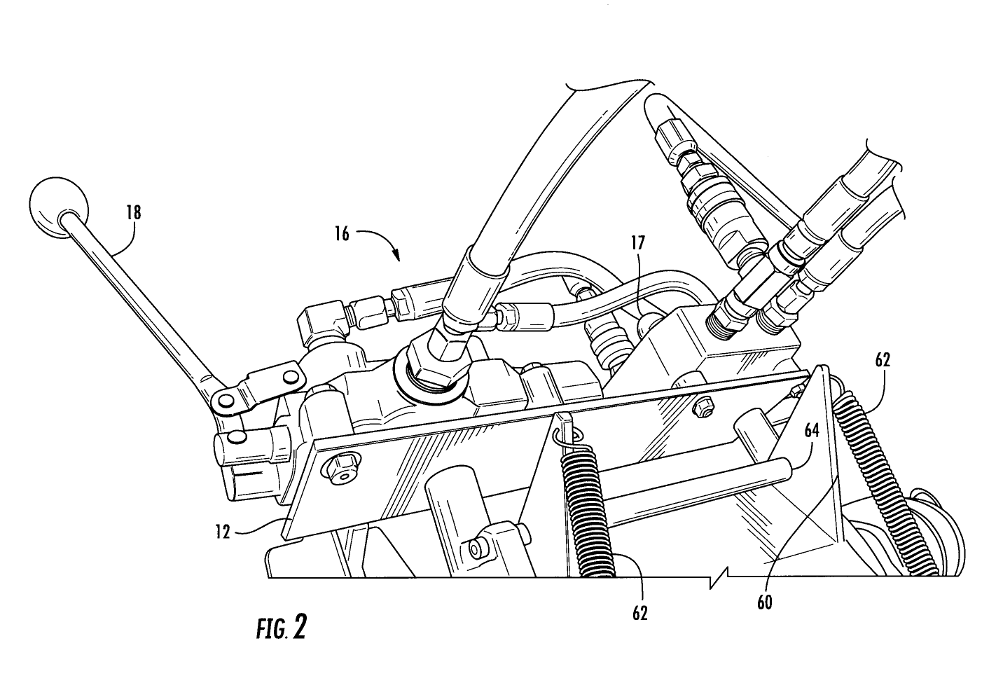

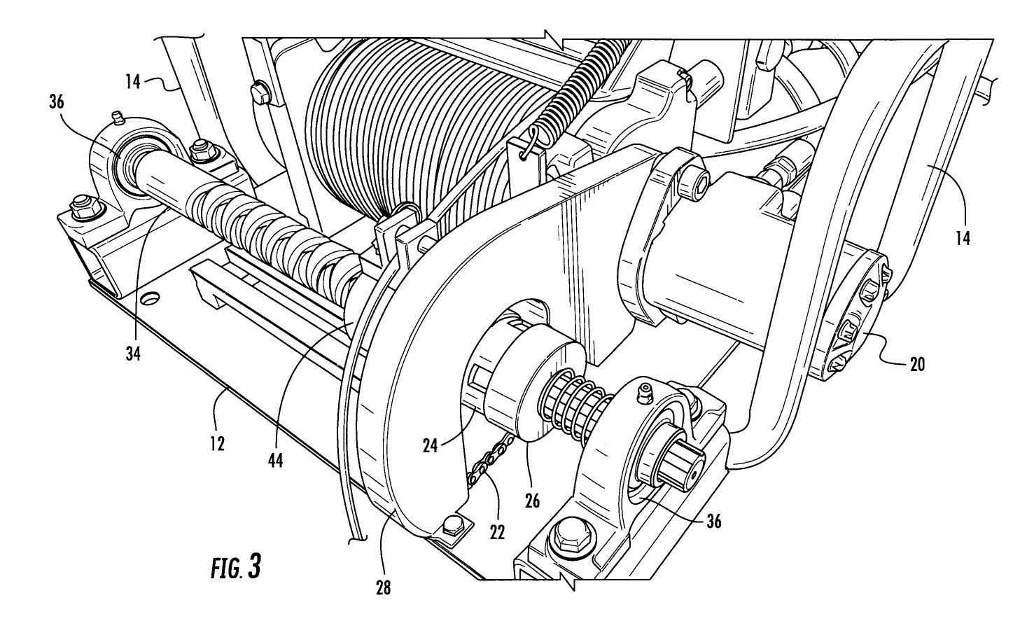

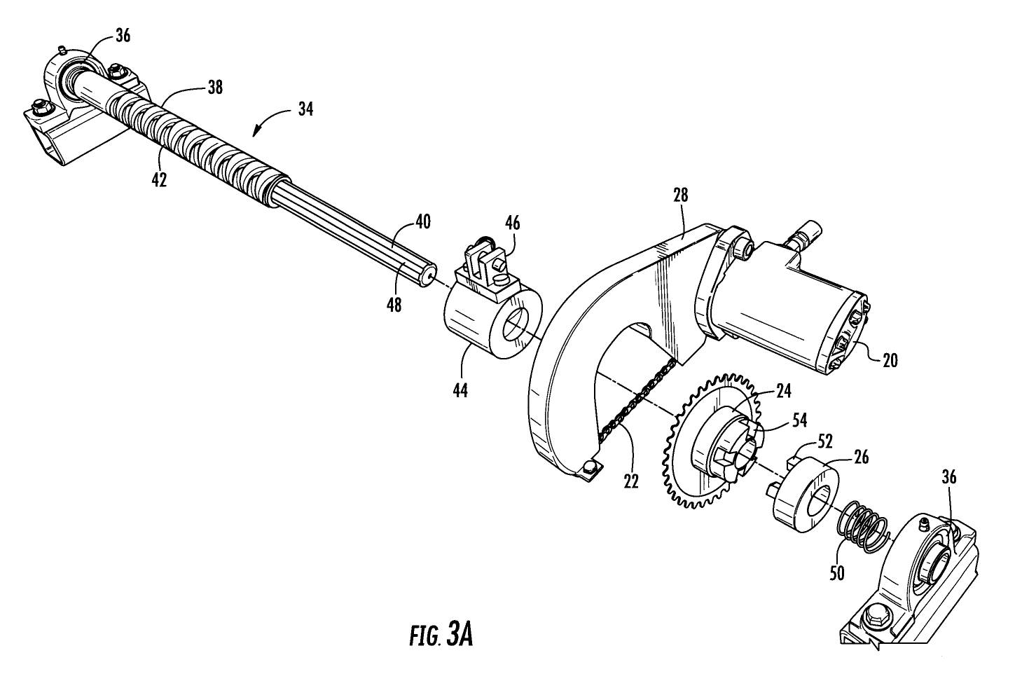

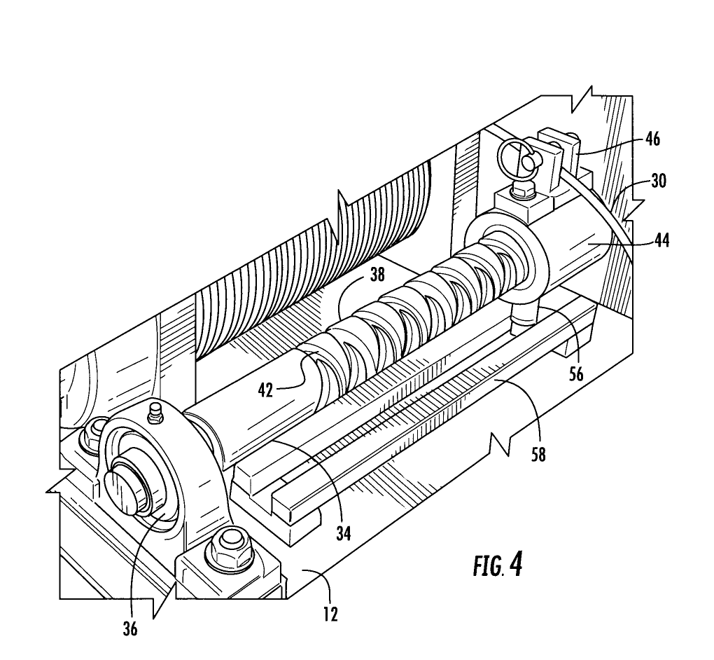

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Generally shown is a winch system as described herein. FIG. 1 generally discloses the winch with a hydraulic system 16 driving a motor 20 which is attached to a frame 12. The hydraulic system 16 may be of any type known in the art. The hydraulic system may provide control for the motor 20 including starting, stopping and controlling the speed of the motor 20. The motor 20 may also be of any type known in the art such as electrical or pneumatic. A directional lever 18 may be provided at a side or top of the hydraulic system 16 to provide a user with the control necessary for the motor 20 to run forward or in reverse. The lever 18 may also be provided at the motor itself. A speed control lever 17 may be provided at any given location to fine tune or calibrate the speed of the winch in any gear position.

Also provided on the frame 12 may be a handle 14. The handle 14 may also be more than one handle provided on either side of the frame 12 for a user to easily transfer the winch from place to place. The handle may be attached to the frame in any manner known in the art. As shown in the figures, the handle 14 may be a bar in a generally rectangular shape with its ends connected by a weld or other connection. The handle 14 may have a main portion disposed below the frame 12, with two end loop portions that are bent upwardly on either side of the frame 12, allowing for a user or users to grab the two end loop portions to move the unit.

The motor 20 may be connected to a drum or spool. The drum or spool is rotated by the motor 20 such that a winch cable 30 which is connected at one end of the winch cable to the drum or spool may be wound up onto the spool for storage. As the winch cable 30 is wound up onto the spool the cable 30 is moved linearly back and forth across the spool such that the winding of the winch cable 30 is a substantially uniform thickness across substantially the length of the drum or spool.

Also connected to the motor 20 is a chain 22 which connects to a cam sprocket 24. A chain cover 28 may substantially cover the chain 22 and the sprocket 24. As the motor 20 is running the chain 22 is driven which is connected to the cam sprocket 24 which is then also rotated. The cam sprocket 24 may have a substantially smooth, cylindrical bore such that as the sprocket 24 is rotated, it may rotate around a cam 34 without driving the cam. The cam 34 is held in place at either end by cam bearings 36, and the cam sprocket 24 has a through hole through which the cam 34 is rotatably disposed. Also located on the cam 34 is a cam gear 26 which may be slidably mounted on the cam 34.

The cam 34 may have a first portion 38 and a second portion 40. The first portion 38 may have guide grooves 42. A cam follower 44 may be disposed on the cam 42 in the first portion 38. The cam follower 44 may be generally cylindrical in shape and slidably disposed on the cam first portion 38. The cam follower 44 may also have a protuberance in the inside diameter of the cam follower, which is disposed in the guide grooves 42 of the cam 34. The cam follower 44 may also have a cable guide 46 disposed on a top portion of the cam follower 44.

The cam 34 may also have a second portion 40. The cam second portion 40 may have a plurality of axial grooves 48. The cam gear 26 may also have corresponding axial grooves or protrusions that fit inside the cam axial grooves 48 such that any rotational movement of the cam gear 26 is transferred to the cam 34. The grooves and protrusions on the cam second portion 40 and the cam gear 26 may also be any other shape or size known in the art to deliver rotational movement. There may also be a gear spring 50 disposed between the bearing 36 and the cam gear 26. The spring 50 is configured to bias the cam gear 26 toward an operating position.

A pressure plate 60 may also be disposed on the winch 10. The pressure plate 60 may have a plate portion 66 which is slidably disposed against the windings of a winch cable 30. The pressure plate 60 may also have a plate axle 64 about which the pressure plate may rotate. The pressure plate may also have a spring 62 which biases the pressure plate against the windings of the winch cable 30, applying pressure to the windings of the winch cable 30. The plate springs 62 are connected at one end to the frame 12 and at the other end to a portion of the pressure plate 60 to allow the pressure plate 60 to rotate about the plate axle 64 such that the plate portion 66 of the pressure plate 60 is biased against the windings of the winch cable 30.

In practice, a user controls the winch system through the lever 18. When the lever 18 is moved to a first position the hydraulic system 16 may drive the motor 20. The motor 20 rotates the winch spool in a direction to begin winding up the winch cable 30. Also as the motor is running it is driving the cam sprocket 24 in the same direction through the chain 22.

The cam gear 26 has a first position in which the teeth 52 of the cam gear 26 are mated with the cam sprocket notches 54 of the cam sprocket 24. The gear spring 50 is configured to put pressure on the cam gear such that the cam gear will not dislocate from the cam sprocket 24 in normal operation. When in the operating position the cam sprocket 24, which is driven by the chain 22, then in turn drives the cam gear 26 through the mated teeth of the sprocket 24 and the cam gear 26. As the cam gear 26 is rotated, the protrusions of the cam gear 26 which are mated with the indentations on the second portions 40 of the cam 34 drives rotation of the cam 34. The cam 34 may be supported on either end by at least two bearings 36. As the cam gear 26 drives the cam second portion 40, which in turn drives the entire cam 34, the cam follower which is slidably disposed on the first portion 42 of the cam 34 is then moved in a linear fashion substantially from one end of the drum or spool to the other and back. The guide grooves 42 in the cam first portion 38, are configured such that the cam follower 44 will slide across the cam 34 from substantially one end of the drum or spool to the other and will reverse course automatically by the design of the grooves 38 of the cam 34.

The cable guide 46 may be disposed on top of the cam follower 44, but also may be disposed in any other position that will allow the winch cable 30 to be guided by the cable guide 46. As the cam follower 44 moves in a linear fashion back and forth, the cable guide 46, which has the winch cable 30 threaded through it, will guide the winch cable 30 onto the spool such that a winding portion of the winch cable 30 is wound onto the spool in a generally uniform fashion. Generally, this is accomplished by configuring the guide grooves 42 on the cam first portion 38 such that with every rotation of the spool, the cam follower is moved linearly a distance substantially equal to the thickness of the winch cable 30. This allows the winch cable to be wound onto the spool in a substantially uniform fashion, wherein the winch cable 30 creates a first layer of windings from substantially one end of the drum to the other before beginning a second layer of windings on top of the first layer of windings. It is important to keep the windings uniform from one end of the drum to the other for both reasons of saving space as well as the ability to keep pressure on the windings such that they do not become unwound with a loss of tension on the end of the winch cable 30.

A pressure plate 60 is disposed on the frame 12 in order to keep pressure on the winding portion of the winch cable 30. The pressure plate 60 may be attached via a pressure plate axle 64 and springs 62 which allow the pressure plate to put pressure on the uniform windings at all times.

The cam follower 44 may also include a follower guide pin 56 disposed below the cam follower 44. A follower guide 58 may be disposed on the frame 12 such that the follower guide pin 56 is slidably disposed within the follower guide 58. As the cam follower 44 travels from one end of the drum or spool to the other and back, the follower guide 58 prevents the follower guide pin 56 from allowing the cam follower 44 substantially any rotational motion. This allows the cam follower 44 and the cable guide 46 to remain in substantially uniform position throughout the movement of the winch system.

The guide grooves 42 disposed within the cam first portion 38 are generally configured to allow a distal end of the winch cable 30 to be wound in a generally uniform fashion onto the drum. However, as the winch cable 30 is wound up onto the drum and the circumference of the windings of the winch cable 30 increases, the linear speed of the cam follower 44 may need to decrease in order to keep the windings substantially uniform. This is based on the rationale that no matter what speed the motor 20 is turning, the drum, cam gear, cam sprocket, and the cam itself will be moving at a constant speed with relation to one another. But as more of the cable 30 is wound onto the spool, the circumference changes. As the circumference of the windings of the winch cable 30 changes, the linear speed of the cam follower 44 will be slightly off from the necessary linear speed in order to wind the winch cable 30 in a generally uniform fashion.

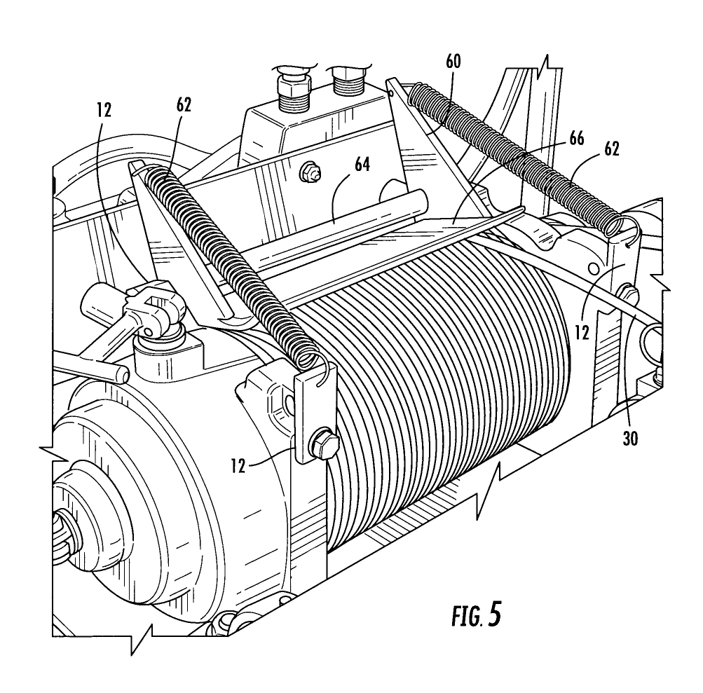

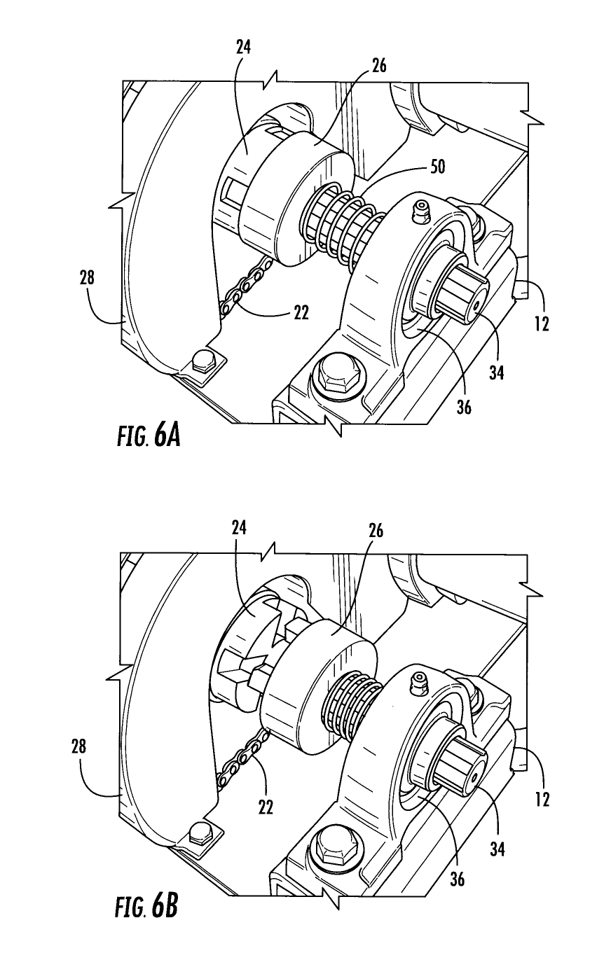

In order to take up the slack from this difference in linear speed, a user may move the cam gear 26 from an operating position (as shown in FIG. 6A) to a manual position (as shown in FIG. 6B). In order for a user to move the cam gear 26 from the operating position to the manual position, the user pulls the cam gear 26 toward the cam bearing 36 that holds up the cam second portion 40. By doing this, the cam rotation is disconnected from the movement of the motor 20 and the cam sprocket 24. The user may then rotate by hand the cam gear 26 and cam 34 in order to manually move the cam follower 44 to a position that substantially lines back up with the windings of the winch cable 30 on the drum. This may be accomplished while the motor 20 is running, and does not necessitate a user to stop the motor and stop the pulling force of the winch. This allows a user more easily to keep the windings of the winch in a generally uniform fashion without having to stop the towing action of the winch, allowing tension on the winch cable 30 to remain substantially constant.

In an embodiment, the winch is used to pull a pipe rehabilitation apparatus, such as a Spincaster in a CentriPipe rehabilitation system (see http://www.centripipe.com). In this embodiment, a rehabilitation layer may be applied to a pipe made of concrete, clay, brick, corrugated metal, or any other material. The pipe to be rehabilitated may be of any shape such as round, oval, square, or any non-standard shape such as triangle, oblong, elliptical, half-round, or any other pipe shape. The pipe further may be vertical, horizontal, or at any angle, and may include turns, bends, or curves. A spray-type apparatus such as a Spincaster with rotating spray arms or impellers may be pulled through the pipe at a constant speed, allowing the liner to be sprayed in the pipe at a generally uniform thickness, and without seams.

In order for the rehabilitation liner to be applied at a constant thickness, it is important that the apparatus be pulled at a generally constant speed. A winch may be used to pull the apparatus while the impellers rotate and apply the liner to the pipe. As shown in FIG. 1, the winch may have a hook end 32 that attaches to the rehabilitation apparatus. The hook end may be a hook formed in the winch cable 30 itself, or it may be a separate hook (not shown) that is attached to the hook end 32 of the winch cable 30 by any method known in the art. The hook end 32 attaches to the rehabilitation apparatus and the winch is started. Because the winch cable is wound around the drum or spool substantially uniformly, the tension is substantially constant on the apparatus as it is pulled from a distal end of the pipe to be rehabilitated to a proximal end. This uniform tension prevents the winch cable from forming slack and allows the apparatus to be pulled without starting and stopping, allowing the liner to be applied generally uniformly within the pipe.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical, mechanical, or pneumatic) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A motorized winch system comprising:
a frame;
a motor;
a drum comprising a first end and a second end operably connected to the motor;
a winch cable comprising a first end connected to the drum and configured to wind around the drum, defining a winding portion that is wound around the drum, and a distal portion; and
a winch cable locator assembly comprising:
a cam bar rotatably mounted to the frame;
a cam follower operably connected to the cam bar such that the cam follower slides from the first end of the drum to the second end of the drum and reverses to slide back to the first end of the drum;
a cable guide coupled to the cam follower, and configured to guide the cable onto the drum; and
a removable cam gear comprising a operating position wherein the cam bar is operably connected to the motor, and a manual position wherein the cam bar is operably disconnected from the motor.

2. The motorized winch system of claim 1, wherein the removable cam gear is moveable from the operating position to the manual position while the motor is running.

3. The motorized winch system of claim 1, wherein the cam bar is moveable by hand and without the use of tools when the cam gear is in the manual position.

4. The motorized winch system of claim 1, wherein the cam bar further comprises a follower trough configured to guide the follower from the first end to the second and back to the first end without intervention by a user.

5. The motorized winch system of claim 1, further comprising a pressure plate rotatably mounted to the frame, comprising a spring configured to bias the pressure plate against the winding portion such that the wound portion remains tight to the drum even if tension is lost on the distal portion.

6. The motorized winch system of claim 1 further comprising a handle configured to allow a user to move the winch without the use of tools.

7. A portable winch system comprising:
a frame comprising a handle;
a motor attached to the frame;
a spool operably connected to the motor and rotatably mounted to the frame;
a winch cable attached to the spool; and
a winch cable locator assembly comprising:
a cam bar rotatably mounted to the frame and comprising a guide portion;
a cam follower rotatably disposed on the cam bar and engaging the guide portion;
a cable guide coupled to the cam follower and slidably engaged with the winch cable; and
a cam gear slidably disposed on and rotatably engaged with the cam bar and comprising an operating position wherein the cam bar is operably connected to the motor, and a manual position wherein the cam bar is operably disconnected from the motor.

8. The portable winch system of claim 7, wherein the guide portion is configured to allow the cam follower to slide from a first end of the spool to a second end of the spool and reverse to slide back to the first end of the spool.

9. The portable winch system of claim 8, wherein the guide portion comprises grooves in the cam bar.

10. The portable winch system of claim 9, wherein the cam follower further comprises a protuberance to fit into the grooves in the cam bar.

11. The portable winch system of claim 7, wherein the removable cam gear is moveable from the operating position to the manual position while the motor is running.

12. The portable winch system of claim 7, wherein the cam bar is moveable by hand and without the use of tools when the cam gear is in the manual position.

13. The portable winch system of claim 7, further comprising a pressure plate rotatably mounted to the frame, the pressure plate comprising a spring configured to bias the pressure plate against a wound portion of the winch cable such that the wound portion remains tight to the spool even if tension is lost on the distal portion.

14. The portable winch system of claim 7, further comprising a cam sprocket operably engaged with the motor.

15. The portable winch system of claim 14, wherein the cam gear comprises a plurality of teeth configured to fit into a corresponding plurality of recesses in the cam sprocket such that when in the operating position, rotational movement is translated from the cam sprocket to the cam gear.

16. A method for winching an apparatus comprising the steps of:
providing a winch including a frame, motor, and drum;
winding a winch cable about the drum by rotating the drum with the motor;
providing constant pressure on the winch cable that is wrapped on the drum with a pressure plate disposed on the frame;
driving a cam by:
attaching a chain at a first end to the motor and at a second end to a cam sprocket;
slidably attaching a cam gear to the cam;
moving the cam gear to a first position, wherein the cam gear and the cam sprocket are operably coupled; and
guiding the winch cable by:
providing a cable guide on a cam follower;
threading the winch cable through the cable guide;
operably and slidably attaching the follower to the cam such that a protrusion on the cam follower is disposed within guide grooves on the cam; and
translating rotational movement of the cam to slidable linear motion of the cam follower such that the winch cable is generally uniformly wound onto the drum.

17. The method of claim 16, wherein the translating step is accomplished by guiding the cam follower from a first end of the drum to a second end of the drum, and back to the first end without user intervention.

18. The method of claim 17, further comprising the steps of:
manually guiding the winch cable by:
moving the cam gear to a second position, wherein the cam gear and the cam sprocket are no longer coupled; and
adjusting the linear location of the cable guide by rotating the cam manually and without the use of tools.

19. The method of claim 16, wherein the apparatus is a Spincaster pipe rehabilitation apparatus.

20. The method of claim 16, wherein the pipe to be rehabilitated is of a non-standard shape.
